(19) United States
(12) Patent Application Publication
(10) Pub. No.: US 2025/0282686 A1
(43) Pub. Date: Sep. 11, 2025

(54) METHODS OF FORMING SUBSTANTIALLY ALL PLATELET ALUMINA POWDERS AND ALUMINA CARRIERS

(71) Applicant: Scientific Design Company, Inc., Little Ferry, NJ (US)

(72) Inventors: Lixin Cao, Little Ferry, NJ (US); Mure Te, Little Ferry, NJ (US); Yunxia Chen, Little Ferry, NJ (US); Li Zhu, Little Ferry, NJ (US); Xiankuan Zhang, Houston, TX (US); Jorge Ron, East Brunswick, NJ (US)

(73) Assignee: Scientific Design LLC, Little Ferry, NJ (US)

(21) Appl. No.: 19/073,726

(22) Filed: Mar. 7, 2025

Related U.S. Application Data
(60) Provisional application No. 63/562,977, filed on Mar. 8, 2024.

(51) Int. Cl. C04B 35/111; C04B 35/626; C04B 41/00

(52) U.S. Cl. CPC C04B 35/111; C04B 35/62675; C04B 41/0072; C04B 2235/3217; C04B 2235/3241; C04B 2235/3256; C04B 2235/3258; C04B 2235/3418; C04B 2235/96

(57) ABSTRACT

A fluxing agent including a Group 6 transition metal, i.e., Cr, Mo or W, is employed in the present application in providing a substantially all platelet alumina powder, or a substantially all platelet alumina carrier.

### CROSS REFERENCE TO RELATED APPLICATION

The present invention claims the benefit of U.S. Provisional Patent Application No. 63/562,977 filed Mar. 8, 2024, the entire content and disclosure of which is incorporated herein by reference.

### FIELD OF THE DISCLOSURE

The present disclosure relates to alumina powders and alumina carriers having a platelet morphology, and more particularly to methods of forming alumina powders and alumina carriers having a substantially all platelet morphology.

### BACKGROUND

Plate-like α-Al₂O₃ particles are important in ceramic industry because of their unique physicochemical properties such as, for example, high strength and hardness, low electrical conductivity, good thermal conductivity, and chemical resistance. As a result, platelet alumina powders are widely used in metals, ceramics and polymers fields, such as raw materials for preparing porous ceramics including catalyst carriers, as fillers to plastics, and as a matrix for pearlescent pigments. Depending on the application, α-Al₂O₃ platelets of various sizes and shapes are typically needed. For example, the fracture toughness and strength of ceramic applications can be substantially improved by reducing the particle size and modifying the morphology of the platelets. However, when used as fillers in thermally conducting composites, large platelets are beneficial because they result in fewer interparticle contacts and thus minimize thermal resistance.

Several techniques have been developed to prepare platelet α-Al₂O₃ powders, such as solid state reaction, microwave combustion, hydrothermal reaction, thermal decomposition and molten salt synthesis. The platelet formation mechanism will be beneficial for the design and synthesis of advanced anisotropic materials with controlled morphology. Platelet alumina powders can also be formed by fluoride mineralizers and flux methods.

While such techniques are known, but each has its limitations, for examples, using of hazardous fluorides, there is a need to provide a new method of forming an alumina power that has a substantially all platelet morphology.

### SUMMARY

A fluxing agent including a Group 6 transition metal, i.e., Cr, Mo or W, is employed in the present application in providing a substantially all platelet alumina powder, or a substantially all platelet alumina carrier. Throughout this disclosure, the term “substantially all” indicates that the alumina powder and the alumina carrier have greater than 96%, preferably 97%, 98% or 99%, more preferably 100%, platelet morphology.

In one aspect of the present application, a method of forming a substantially all platelet alumina powder is provided. In one embodiment, the method comprises forming an aqueous slurry comprising an alumina source and a fluxing agent, wherein the fluxing agent has a formula MO₃ wherein M is a metal selected from Cr, Mo and W, and the fluxing agent is present in the aqueous slurry in an amount from about 0.1 weight % to about 5 weight %, based on the total weight of the alumina source; drying the slurry to provide a solid product; and calcining the solid product at a temperature of about 1200° C. or greater to convert the solid product into a substantially all platelet alumina powder.

In another aspect of the present application, a method of forming a substantially all platelet alumina carrier is provided. In one embodiment, the method comprises adding a fluxing agent to a carrier composition comprising an alumina source, wherein the fluxing agent has a formula MO₃ wherein M is a metal selected from Cr, Mo and W, and wherein the fluxing agent is added in an amount from about 0.1 weight % to about 5 weight % based on the total weight of the alumna source; mixing the fluxing agent and the carrier composition to provide an admixture of the fluxing agent and the carrier composition; forming the admixture into a shaped body and calcining the shaped body at a temperature of about 1200° C. or greater to convert the shaped body into a substantially all platelet alumina carrier.

### BRIEF DESCRIPTION OF THE DRAWINGS

FIG. 1 is a scanning electron micrograph (SEM) of alumina powder 1 of Example 1.

FIG. 2 is a SEM of alumina powder 2 of Example 1.

FIG. 3 is a SEM of alumina powder 3 of Example 1.

FIG. 4 is a SEM of alumina powder 4 of Example 1.

FIG. 5 is a SEM of alumina powder 5 of Example 1.

FIG. 6 is a SEM of alumina powder 6 of Example 1.

FIG. 7 is a SEM of alumina powder 7 of Example 1.

FIG. 8 is a SEM of alumina powder 8 of Example 1.

FIG. 9 is a SEM of alumina powder 9 of Example 2.

FIG. 10 is a SEM of alumina powder 10 of Example 2.

FIG. 11 is a SEM of alumina powder 11 of Example 2.

FIG. 12 is a SEM of alumina powder 12 of Example 2.

FIG. 13 is a SEM of alumina powder 13 of Example 2.

FIG. 14 is a SEM of alumina powder 14 of Example 2.

FIG. 15 is a SEM of alumina powder 15 of Example 2.

FIG. 16 is a graph showing the mercury pore volume distribution (HgPVD) of various alpha alumina carriers, i.e., carriers 1-4 of Example 3.

FIG. 17 is a fractured surface SEM of an alpha alumina carrier, i.e., carrier 1 of Example 3, in accordance with the present disclosure.

FIG. 18 is a fractured surface SEM of an alpha alumina carrier, i.e., carrier 2 of Example 3 in accordance with the present disclosure.

FIG. 19 is a fractured surface SEM of an alpha alumina carrier, i.e., carrier 3 of Example 3 in accordance with the present disclosure.

FIG. 20A is a fractured surface SEM of an alpha alumina carrier, i.e., carrier 4 of Example 3 in accordance with the present disclosure before washing.

FIG. 20B is a fractured surface SEM of an alpha alumina carrier, i.e., carrier 4 of Example 3. in accordance with the present disclosure after washing.

FIG. 21 is a graph showing the mercury pore volume distribution (HgPVD) of an alpha alumina carrier in accordance with the present disclosure before and after washing.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

### I. Platelet Alumina Powder Formation

The method of forming an alumina powder having a substantially all platelet morphology will now be described in greater detail. The method includes forming an aqueous slurry comprising an alumina source and a fluxing agent. In the present application, the aqueous slurry is a mixture that includes at least an alumina source that is suspended in water. In the present disclosure, the slurry can have a solid content that can be from about 25% to 50%, with a solid content from about 30% to 45% being more preferred. Other solid contents can also work and employed as long as the solid content allows uniform fluxing agent dispersion. The solid content constitutes the amount of alumina source and other optional solid components such as, for example, silica that can be contained in the slurry.

In the present disclosure, the alumina source that can be used in the method of the present disclosure includes any alumina compound that is typically used in forming alumina powders. The term “alumina” is used throughout this disclosure to denote alumina oxide. In embodiments of the present disclosure, the alumina source can be a single alumina compound or a mixture of two or more alumina compounds. In embodiments of the present disclosure, the alumina source is a transition alumina. The transition alumina that can be employed in this disclosure can be in various crystalline phases such as, for example, γ, θ and κ. A transition alumina containing hydrate alumina is preferred in some embodiments of the present disclosure. Examples of alumina hydrates that can be employed in the present disclosure as the alumina source include, but are not limited to, boehmite (γ-AlOOH), gibbsite (α-Al(OH)₃) or mixtures thereof. Alumina sources that can be used in the present disclosure can be purchased from numerous suppliers including, for example, GNPGraystar and Nabaltec.

In embodiments of the present disclosure, the alumina source can have a mean particle size, D₅₀, from about 0.1 μm to about 20 μm, with a mean particle size of from about 0.3 μm to 15 μm being more preferred. In the present disclosure, the mean particle size, D₅₀, denotes that half the particles have a size that is below a given number and half the particles have a size that is above the given number. The mean particle size, D₅₀, reported in the present disclosure can be determined by particle size analysis.

The alumina source that can be employed in the present disclosure can contain various impurities, i.e., unintentionally added components, that are present in the alumina source. Illustrative examples of such impurities that can be present in the alumina source include, but are not limited to, SiO₂, Na₂O, Fe₂O₃ and mixtures thereof. In the present disclosure, the total impurity content in the alumina source is typically about 4000 ppm or less, with a total impurity content in the alumina source from about 100 ppm to 500 ppm being more preferred.

In addition to an alumina source, the slurry can further include an additional solid component that is intentionally added into the slurry. The additional solid component that can be used in the present disclosure can be a shape controlling agent such as, for example, silicon, a silicon compound, germanium or a germanium compound. When present, the additional solid component can present in the slurry in an amount from about 0.1 weight % to about 5 weight %, based on the total weight of the alumina source, with an amount from about 0.3 weight % to about 0.5 weight % being more preferred. In one exemplary embodiment of the present disclosure, silica is used as an additional solid component that can present in the slurry. When silica is employed, the silica is present in the slurry in an amount from about 0.1 weight % to about 5 weight %, more preferably from about 0.1 weight % to about 0.3 weight, based on the total weight of the alumina source.

As mentioned above, the slurry is an aqueous slurry in which water is used as the solvent. The water is typically deionized water.

As mentioned above, a fluxing agent is also present in the aqueous slurry. The term “fluxing agent” is used throughout the present disclosure to denote a compound that facilitates formation of platelets. The fluxing agent that can be employed in the present disclosure has a formula MO₃ wherein M is a metal from selected from Cr, Mo and W. In one preferred embodiment, M is Mo and the fluxing agent is MoO₃. In another preferred embodiment, M is W and the fluxing agent is WO₃. The fluxing agent is typically added in the form of a metal complex including ammonium and the MO₃ moiety mentioned above. In such complexes, the ammonium readily dissociates from the MO₃ moiety when subjected to heat treatment.

In embodiments in forming the substantially all platelet alumina powder of the present disclosure, the fluxing agent is present in the aqueous slurry in an amount from about 0.1 weight % to about 10 weight %, more preferably in an amount from about 0.5 weight % to about 5 weight %, and even more preferably in an amount from about 2 weight % to about 4 weight %, based on the total weight of the alumina source.

The slurry is formed by adding the alumina source, optional shape controlling agent or other solid component, and the fluxing agent into water. The addition of the alumina source, optional shape controlling agent or other solid component, and the fluxing agent can vary. In embodiments, it is preferred to add the flux agent into a mixture of water, alumina source and optional shape controlling agent. The slurry can be formed utilizing conventional slurry processes well known to those skilled in the art. The slurry typically occurs in the presence of continuous stirring and is typically performed at nominal room temperature. In the present disclosure, nominal room temperature can be defined as a temperature from about 18° C. to about 25° C.

The method of forming the substantially all platelet alumina powder continues by drying the slurry to provide a solid product which typically has some degree of moisture associated therewith. In some embodiments, the solid product can have a moisture content of from about 1 weight % to about 10 weight %. That is, the drying step of the present disclosure does not provide a solid product that is entirely without any moisture. Instead, the drying step partially removes water from the solid product. In embodiments of the present application, the drying step is performed at a temperature from about 50° C. to about 90° C., with a drying temperature of from about 70° C. to about 80° C. being more preferred The drying step can be performed utilizing conventional dry apparatuses that are well known to those skilled in the art. In one exemplary embodiment, the drying step is performed under a heat lamp.

After drying, the method of forming the substantially all platelet alumina powder continues by calcining (i.e., firing) the solid product at a temperature of about 1200° C. or greater, with a calcining temperature from about 1100° C. to about 1500° C. being more typical. A single continuous calcining temperature can be employed, or various ramp up and hold cycles can be used during the calcining step. The calcining step can be performed for various times depending on the exact calcining temperature(s) used. Typically, calcination is performed for a time period for 1 hour to 15 hours, with a time period from about 3 hours to 10 hours being more preferred. During the calcinating step, the solid product is typically exposed to air. The above calcining conditions are sufficient to remove any remaining solvent that is present in the solid product. The above calcining conditions are also sufficient to at least removed some of the fluxing agent content from the alumina powders that are produced by the method of present disclosure.

The calcining step converts the solid product into a substantially all platelet alumina powder. The substantially all platelet alumina powder is typically an alpha alumina powder. The alumina powders that are produced by the method of the present application are characterized as having a platelet content that is greater than 96%, preferably 97%, 98% or 99%, more preferably 100%. The substantially all platelet alumina powder has a platelet aspect ratio of from about 1:1 or greater, with a platelet aspect ratio of from about 5:1 to about 10:1 being more preferred. In the present disclosure, the platelet aspect ratio is a ratio of the platelet's width to platelet's height and the ranges reported herein for the platelet aspect ratio represents an average value of each of the measured platelets within the alumina powder. The platelet aspect ratio can be determined by measurements from the SEM images of the powders.

The substantially all platelet alumina powder that is formed by the method of the present disclosure can have a mean particle size from about 0.1 μm to about 5 μm, with a mean particle size of from about 1 μm to 2 μm being more highly preferred. The substantially all platelet alumina powder that is formed by the method of the present disclosure can have a surface area from about 0.1 m²/g to about 5 m²/g, with a surface area from about 1 m²/g to about 2 m²/g being more preferred.

The substantially all platelet alumina powders that are produced by the method of the present disclosure can be widely used in metals, ceramics and polymers fields, as well as porous ceramics including catalyst carriers, as fillers to plastics, and as a matrix for pearlescent pigments. In a highly preferred embodiment of the present disclosure, the substantially all platelet alumina powders formed by the method of the present application can be used in forming a catalyst carrier, particularly an ethylene oxide (EO) catalyst carrier. In forming EO catalyst carriers, the substantially all platelet alumina powders that are formed utilizing the method of the present application can be used in any EO catalyst carrier preparation process as one of the alumina sources that are employed in forming the EO carrier.

### II. Platelet Alumina Carrier Formation

The method of forming an alumina carrier having a substantially all platelet morphology will now be described in greater detail. The method of forming the substantially all platelet alumina carrier includes adding a fluxing agent to a carrier composition. In this aspect of the present application, the fluxing agent that can be employed in the method of forming the substantially all platelet alumina carrier is the same as that described above in forming the substantially all platelet alumina powders. That is, the fluxing agent that can be employed in forming the substantially all platelet alumina has a formula MO₃ wherein M is a metal from selected from Cr, Mo and W. In one preferred embodiment, M is Mo and the fluxing agent is MoO₃. In another preferred embodiment, M is W and the fluxing agent is WO₃. The fluxing agent is typically added in the form of a metal complex including ammonium and the MO₃ moiety mentioned above.

In embodiments in forming the substantially all platelet alumina carrier of the present disclosure, the fluxing agent is added to a carrier composition in an amount from about 0.5 weight % to about 5 weight %, more preferably in an amount from about 1 weight % to about 3 weight %, and even more preferably in an amount from about 2 weight % to about 2.5 weight %, based on the total weight of an alumina source that provides a part of the carrier composition.

The alumina source that provides a part of the carrier composition includes one of the alumina sources mentioned above in forming the substantially all platelet alumina powder. In embodiments of the present disclosure, the alumina source can be a single alumina compound or a mixture of two or more alumina compounds. In embodiments of the present disclosure, the alumina source is a transition alumina. The transition alumina that can be employed in this disclosure can be in various crystalline phases such as, for example, γ, θ and κ. A transition alumina containing alumina hydrate is preferred in some embodiments of the present disclosure. Examples of alumina hydrates that can be employed in the present disclosure as the alumina source used in forming the include, but are not limited to, boehmite (γ-AlOOH), gibbsite (α-Al(OH)₃) or mixtures thereof.

In embodiments of the present disclosure, the alumina source can have a mean particle size, D₅₀, from about 0.1 μm to about 20 μm, with a mean particle size of from about 0.3 μm to 15 μm being more preferred. In embodiments, of the present disclosure, the alumina source can have a surface area from about 10 m²/gm to about 200 m²/gm, with a surface area from about 15 m²/gm to about 180 m²/g being more preferred.

The alumina source that can be employed in the present disclosure can contain various impurities, i.e., unintentionally added components, that are present in the alumina source. Illustrative examples of such impurities that can be present in the alumina source include, but are not limited to, SiO₂, Na₂O, Fe₂O₃ and mixtures thereof. In the present disclosure, the total impurity content in the alumina source is typically about 4000 ppm or less, with a total impurity content in the alumina source from about 100 ppm to 500 ppm being more preferred.

In addition to an alumina source, the carrier composition of the present application can include an additional solid component that is intentionally used in forming a carrier composition. The additional solid component that can be used in the present disclosure can be a shape controlling agent such as, for example, silicon, a silicon compound, germanium or a germanium compound. When present, the additional solid component can be employed in an amount from about 0.1 weight % to about 5 weight %, based on the total weight of the alumina source, with an amount from about 0.3 weight % to about 0.5 weight % being more preferred. In one exemplary embodiment of the present disclosure, silica is used as an additional solid component. When silica is employed, the silica is present in an amount from about 0.1 weight % to about 0.7 weight %, more preferably from about 0.3 weight % to about 0.5 weight %, based on the total weight of the alumina source.

In some embodiments of the present disclosure, the carrier composition can further include a burnout material. Exemplary burnout materials that can be used in the present disclosure include, but are not limited to, polypropylenes, polyethylenes, carbohydrates, gums, flours, protein, lignins, resins, waxes, alcohols, and esters. When employed, the burnout material can be present in the carrier composition in an amount from about 1 weight % to about 10 weight %, more preferably from about 5 weight % to about 9 weight percent, relative to the total amount of alumina source present in the carrier composition. In some embodiments, no burnout material is employed in forming the substantially all platelet alumina carrier of the present disclosure.

In some embodiments, the carrier composition can further include a non-silicate binder, a lubricate, a solvent or any combinations of these components. The non-silicate binder can include, for example, boehmite (γ-AlOOH). Typically, the non-silicate binder is dispersed into deionized water. The lubricant can include any conventional lubricant such as, for example, petroleum jelly. The amount of lubricant that can be added at this point of the present disclosure may comprise the total amount of, or a partial amount, of the lubricant that used in forming the alumina carrier of the present disclosure.

After adding the fluxing agent to the carrier composition or during the addition process itself, mixing is employed to provide an admixture of the fluxing agent and the carrier composition (plus any of the other carrier composition components mentioned above). The admixture can be referred to as a precursor carrier mixture. The mixing provide a homogenous admixture. The mixing step can be carried out utilizing any conventional mixing apparatus and the speed and length of the mixing step can vary and it is necessarily critical to form a homogeneous mixture in the present disclosure.

The admixture is then formed to provide a shaped body. The shape of the shaped body can vary. Forming of the shaped body is typically performed by pressing, extrusion, molding, casting, etc. In some preferred embodiments of the present disclosure, extruding may be performed using an extruder die that can produce hollow cylinder shapes which then can be cut to pieces of substantially equal length. The extrudate after cutting is then dried using any conventional drying means. Subsequently, the dried extrudate can be transferred into a furnace in order to remove the water and burn out most of the burnout materials and other organic components that may be present. Depending on the burnout material type, heat treatment can be performed at temperatures from 100° C. to 1,000° C. with heating rates varying between 10° C./hr to 100° C./hr.

Subsequently, the extrudate can be calcined (i.e., sintered) at a temperature of about 1100° C. or greater, preferably from about 1250° C. to about 1600° C., to convert the admixture into a substantially all platelet alumina carrier. The calcinating step employed in forming the alumina carriers can be performed in air, an inert ambient of any combination thereof. In one example, the calcinating step can be in flowing air. After the calcinating step, the resultant alumina carrier is cooled to room temperature. The heating and cooling rates can be within a range from 1° C./min up to 5° C./min. Other heating and cooling rates within a range from 0.5° C./min up to 20° C./min can also be used in the present disclosure for providing the alumina carrier.

The alumina carrier that is formed using the above method is a substantially all platelet alumina carrier. The substantially all platelet alumina carrier is typically an alpha alumina carrier. The alumina carriers that are produced by the method of the present application are characterized as having a platelet content that is greater than 96%, preferably 97%, 98% or 99%, more preferably 100%. The substantially all platelet alumina carrier has a platelet aspect ratio of from about 5:1 or greater, with a platelet aspect ratio of from about 10:1 to about 20:1 being more preferred. In the present disclosure, the platelet aspect ratio is a ratio of the platelet's width to platelet's height and the ranges reported herein for the platelet aspect ratio represents an average value of each of the measured platelets within the alumina carrier The platelet aspect ratio can be determined by SEM measurements.

Fluxing agent content within the carrier can be lowered by washing the as produced substantially all platelet alumina carrier. Washing can include a water wash which can be performed once or more than once (i.e., multiple washing can be used to reduced fluxing agent content in the substantially all platelet alumina carrier).

The substantially all platelet alumina carrier of the present disclosure has a surface area from about 0.2 m²/gm to about 2 m²/gm, with a surface area from about 1.5 m²/gm to about 2.0 m²/gm being more preferred. The substantially all platelet alumina carrier of the present disclosure has a water absorption from about 30% to about 90%, with a water absorption from about 40% to about 85% being more preferred. The water absorption is determined herein by typical water absorption measurements well known in the art. The substantially all platelet alumina carrier of the present disclosure has a mercury pore volume from about 0.3 ml/g to about 0.9 ml/g, with a mercury pore volume from about 0.4 ml/g to about 0.85 ml/g being more preferred. The substantially all platelet alumina carrier of the present disclosure has an average crush strength from about 50 N to about 300 N, with an average crush strength from about 100 N to about 200 N being more preferred.

In some embodiments, the substantially all platelet alumina carrier contains less than 1%, preferably less than 0.1%, of volume of total pore volumes for pore sizes less than 0.3 μm. In some embodiments of the present disclosure, the substantially all platelet alumina carrier has a pore mode within a range from about 0.1 μm to about 10 μm, with a pore mode within a range from about 1 μm to about 3 μm being more preferred.

### III. Catalyst Supported by the Platelet Alumina Carrier

In another embodiment, the platelet alumina carriers described above can be used as a catalyst carrier (i.e., catalyst support), in which case it typically contains one or more catalytically active species, typically metals, disposed on or in the platelet alumina carrier. The one or more catalytically active materials can catalyze a specific reaction and are well known in the art. In some embodiments, the catalytically active material includes one or more transition metals from Groups 3-14 of the Periodic Table of Elements and/or lanthanides. In such applications, one or more promoting species (i.e., species that aide in a specific reaction) can be also disposed on or in the porous body of the present disclosure. The one or more promoting species may be, for example, alkali metals, alkaline earth metals, transition metals, and/or an element from Groups 15-17 of the Periodic Table of Elements.

In an embodiment in which the platelet alumina carrier of the present disclosure is employed as carrier for silver-based epoxidation catalysts, the platelet alumina carrier includes silver on and/or in the carrier. Thus, in the method described above, generally after the sintering step, silver is incorporating on or into the platelet alumina carrier by means well known in the art, e.g., by impregnation of a silver salt followed by thermal treatment, as well known in the art, as described in, for example, U.S. Pat. Nos. 4,761,394, 4,766,105, 4,908,343, 5,057,481, 5,187,140, 5,102,848, 5,011,807, 5,099,041 and 5,407,888, all of which are incorporated herein by reference. The concentration of silver salt in the solution is typically in the range from about 0.1% by weight to the maximum permitted by the solubility of the particular silver salt in the solubilizing agent employed. More typically, the concentration of silver salt is from about 0.5% by weight of silver to 45% by weight of silver, and even more typically, from about 5% by weight of silver to 35% by weight of silver by weight of the platelet alumina carrier. The foregoing amounts are typically also the amounts by weight found in the catalyst after thermal treatment. To be suitable as an ethylene epoxidation catalyst, the amount of silver should be a catalytically effective amount for ethylene epoxidation, which can be any of the amounts provided above.

In addition to silver, the silver-based epoxidation catalyst of the present invention can also include any one or more promoting species in a promoting amount. The one or more promoting species can be incorporated into the platelet alumina carrier of the present disclosure either prior to, coincidentally with, or subsequent to the deposition of the silver. As used herein, a “promoting amount” of a certain component of a catalyst refers to an amount of that component that works effectively to provide an improvement in one or more of the catalytic properties of the catalyst when compared to a catalyst not containing said component.

For example, the silver-based epoxidation catalyst can include a promoting amount of a Group I alkali metal or a mixture of two or more Group 1 alkali metals. Suitable Group 1 alkali metal promoters include, for example, lithium, sodium, potassium, rubidium, cesium or combinations thereof. Cesium is often preferred, with combinations of cesium with other alkali metals also being preferred. The amount of alkali metal will typically range from about 10 ppm to about 3000 ppm, more typically from about 15 ppm to about 2000 ppm, more typically from about 20 ppm to about 1500 ppm, and even more typically from about 50 ppm to about 1000 ppm by weight of the total catalyst, expressed in terms of the alkali metal.

The silver-based epoxidation catalyst can also include a promoting amount of a Group 2 alkaline earth metal or a mixture of two or more Group 2 alkaline earth metals. Suitable alkaline earth metal promoters include, for example, beryllium, magnesium, calcium, strontium, and barium or combinations thereof. The amounts of alkaline earth metal promoters are used in similar amounts as the alkali metal promoters described above.

The silver-based epoxidation catalyst can also include a promoting amount of a main group element or a mixture of two or more main group elements. Suitable main group elements include any of the elements in Groups 13 (boron group) to 17 (halogen group) of the Periodic Table of the Elements. In one example, a promoting amount of one or more sulfur compounds, one or more phosphorus compounds, one or more boron compounds or combinations thereof can be used.

The silver-based epoxidation catalyst can also include a promoting amount of a transition metal or a mixture of two or more transition metals. Suitable transition metals can include, for example, the elements from Groups 3 (scandium group), 4 (titanium group), 5 (vanadium group), 6 (chromium group), 7 (manganese group), 8-10 (iron, cobalt, nickel groups), and 11 (copper group) of the Periodic Table of the Elements, as well as combinations thereof. More typically, the transition metal is an early transition metal selected from Groups 3, 4, 5, 6, or 7 of the Periodic Table of Elements, such as, for example, hafnium, yttrium, molybdenum, tungsten, rhenium, chromium, titanium, zirconium, vanadium, tantalum, niobium, or a combination thereof.

In one embodiment of the present disclosure, the silver-based epoxidation catalyst includes silver, cesium, and rhenium. In another embodiment of the present disclosure, the silver-based epoxidation catalyst includes silver, cesium, rhenium and one or more species selected from Li, K, W, Zn, Mo, Mn, and S.

The silver-based epoxidation catalyst can also include a promoting amount of a rare earth metal or a mixture of two or more rare earth metals. The rare earth metals include any of the elements having an atomic number of 57-71, yttrium (Y) and scandium (Sc). Some examples of these elements include lanthanum (La), cerium (Ce), and samarium (Sm).

The transition metal or rare earth metal promoters are typically present in an amount of from about 0.1 micromoles per gram to about 10 micromoles per gram, more typically from about 0.2 micromoles per gram to about 5 micromoles per gram, and even more typically from about 0.5 micromoles per gram to about 4 micromoles per gram of total catalyst, expressed in terms of the metal. All of the aforementioned promoters, aside from the alkali metals, can be in any suitable form, including, for example, as zerovalent metals or higher valent metal ions.

The silver-based epoxidation catalyst can also include an amount of rhenium (Re), which is known as a particularly efficacious promoter for ethylene epoxidation high selectivity catalysts. The rhenium component in the catalyst can be in any suitable form, but is more typically one or more rhenium-containing compounds (e.g., a rhenium oxide) or complexes. The rhenium can be present in an amount of, for example, about 0.001 wt. % to about 1 wt. %. More typically, the rhenium is present in amounts of, for example, about 0.005 wt. % to about 0.5 wt. %, and even more typically, from about 0.01 wt. % to about 0.05 wt. % based on the weight of the total catalyst including the support, expressed as rhenium metal. All of these promoters, aside from the alkali metals, can be in any suitable form, including, for example, as zerovalent metals or higher valent metal ions.

After impregnation with silver and any promoters, the impregnated platelet alumina carrier is removed from the solution and calcined for a time sufficient to reduce the silver component to metallic silver and to remove volatile decomposition products from the silver-containing support. The calcination is typically accomplished by heating the impregnated platelet alumina carrier, preferably at a gradual rate, to a temperature in a range of about 200° C. to about 600° C., more typically from about 200° C. to about 500° C., more typically from about 250° C. to about 500° C., and more typically from about 200° C. or 300° C. to about 450° C., at a reaction pressure in a range from about 0.5 to about 35 bar. In general, the higher the temperature, the shorter the required calcination period. A wide range of heating periods have been described in the art for the thermal treatment of impregnated supports. See, for example, U.S. Pat. No. 3,563,914, which indicates heating for less than 300 seconds, and U.S. Pat. No. 3,702,259, which discloses heating from 2 to 8 hours at a temperature of from 100° C. to 375° C. to reduce the silver salt in the catalyst. A continuous or step-wise heating program can be used for this purpose. During calcination, the impregnated support is typically exposed to a gas atmosphere comprising an inert gas, such as nitrogen. The inert gas can also include a reducing agent.

In another aspect, the present disclosure is directed to a method for the vapor phase production of ethylene oxide by conversion of ethylene to ethylene oxide in the presence of oxygen by use of the silver-based epoxidation catalyst described above. Generally, the ethylene oxide production process is conducted by continuously contacting an oxygen-containing gas with ethylene in the presence of the catalyst at a temperature in the range from about 180° C. to about 330° C., more typically from about 200° C. to about 325° C., and more typically from about 225° C. to about 270° C., at a pressure which can vary from about atmospheric pressure to about 30 atmospheres depending on the mass velocity and productivity desired. Pressures in the range of from about atmospheric to about 500 psi are generally employed. Higher pressures can, however, be employed within the scope of the invention. Residence times in large-scale reactors are generally on the order of about 0.1 to about 5 seconds. A typical process for the oxidation of ethylene to ethylene oxide comprises the vapor phase oxidation of ethylene with molecular oxygen in the presence of the inventive catalyst in a fixed bed, tubular reactor. Conventional commercial fixed bed ethylene oxide reactors are typically in the form of a plurality of parallel elongated tubes (in a suitable shell). In one embodiment, the tubes are approximately 0.7 to 2.7 inches O.D. and 0.5 to 2.5 inches I.D. and 15-45 feet long filled with catalyst.

In some embodiments, the silver-based epoxidation catalyst described above exhibits a high level of selectivity in the oxidation of ethylene with molecular oxygen to ethylene oxide. For example, a selectivity value of at least about 83 mol % up to about 93 mol % can be achieved. In some embodiments, the selectivity is from about 87 mol % to about 93 mole %. The conditions for carrying out such an oxidation reaction in the presence of the silver-based epoxidation catalyst described above broadly comprise those described in the prior art. This applies, for example, to suitable temperatures, pressures, residence times, diluent materials (e.g., nitrogen, carbon dioxide, steam, argon, and methane), the presence or absence of moderating agents to control the catalytic action (e.g., 1, 2-dichloroethane, vinyl chloride or ethyl chloride), the desirability of employing recycle operations or applying successive conversion in different reactors to increase the yields of ethylene oxide, and any other special conditions which can be selected in processes for preparing ethylene oxide.

In the production of ethylene oxide, reactant feed mixtures typically contain from about 0.5 to about 45% ethylene and from about 3 to about 15% oxygen, with the balance comprising comparatively inert materials including such substances as nitrogen, carbon dioxide, methane, ethane, argon and the like. Only a portion of the ethylene is typically reacted per pass over the catalyst. After separation of the desired ethylene oxide product and removal of an appropriate purge stream and carbon dioxide to prevent uncontrolled build-up of inert products and/or by-products, unreacted materials are typically returned to the oxidation reactor.

Examples have been set forth below for the purpose of further illustrating the present disclosure. The scope of the present disclosure is not to be in any way limited by the examples set forth herein. In the following examples, various alumina hydrate powders are employed as an alumina source. Table 1 provides a listing of the various alumina hydrate powders that are employed in the examples of the present disclosure. Table 1 also includes values of the mean particle size (D₅₀), surface area (SA) and main impurities of each of the alumina hydrate powders listed in Table 1.

TABLE 1
Alumina Hydrate Powders

| | D₅₀ | SA | SiO₂ | Na₂O | Fe₂O₃ |
|---|---|---|---|---|---|
| | (μm) | (m²/gm) | (ppm) | (ppm) | (ppm) |
| Gibbsite-1 | 9 | 2 | 50 | 2400 | 70 |
| Boehmite-1 | 10-15 | N/A | N/A | <500 | N/A |
| Boehmite-2 | 0.3 | 17 | 100 | 4000 | 100 |
| Gibbisite-2 | 1.5 | 3.5 | 100 | 4000 | 100 |

### Example 1: Tungsten Oxide Assisted Platelet Alumina Powder Formation

In this example, various alumina powders were prepared using a WO₃ fluxing agent. Notably, mixture composition 1-8 as identified in Table 2A were prepared by slurring an alumina hydrate powder, as listed in Table 2A and further identified in Table 1, with various levels of silica and WO₃, as also listed in Table 2A, in deionized (DI) water. The slurry solid content for each of mixture compositions 1-8 is provided in Table 2B.

TABLE 2A
Mixture Composition For Platelet Alumina
Powder Preparation Using WO₃ Flux

| | Al₂O₃ | Alumina | Added silica | |
|---|---|---|---|---|
| Mixture | Content | Hydrate | Content | WO₃ |
| Composition | (wt. %) | Powder | (wt. %) | (wt. %)¹ |
| 1 | 93.2 | Gibbsite-1 | 1.9 | 4.9 |
| 2 | 93.3 | Gibbsite-1 | 1.8 | 4.9 |
| 3 | 96.4 | Gibbsite-1 | 0.9 | 2.6 |
| 4 | 98.2 | Gibbsite-1 | 0.5 | 1.3 |
| 5 | 99.1 | Gibbsite-1 | 0.4 | 0.5 |
| 6 | 99.4 | Gibbsite-1 | 0.4 | 0.3 |
| 7 | 97.0 | Gibbsite-2 | 0.5 | 2.5 |
| 8 | 97.1 | Boehmite-1 | 0.5 | 2.5 |

¹WO₃ from (NH₄)₆H₂W₁₂O₄₀

After forming the mixture compositions listed in Table 2A, those mixture compositions were dried under a heat lamp and calcined using the conditions set forth in Table 2B.

TABLE 2B
Experimental Conditions For Platelet Alumina
Powder Preparation Using WO₃ Flux

| | | | Calcining | |
|---|---|---|---|---|
| Mixture | Slurry | Drying Time | Temperature | Calcining Time |
| Composition | Solid % | (hrs) | (° C.) | (hrs) |
| 1 | 39 | 3 | 1250 | 10 |
| 2 | 39 | 3 | 1250 | 3 |
| 3 | 37 | 3 | 1250 | 3 |
| 4 | 37 | 3 | 1250 | 3 |
| 5 | 37 | 3 | 1250 | 3 |
| 6 | 36 | 3 | 1250 | 3 |
| 7 | 37 | 3 | 1450 | 3 |
| 8 | 43 | 3 | 1250 | 3 |

Following the calcination process, alumina powders 1-8 were prepared from mixture compositions 1-8, respectively. As noted in Table 2C, alumina powers 1, 2, 7 and 8 had a 100% platelet morphology, while alumina powder 3 has a substantially 100% platelet morphology. Alumina powers 4-6 had some (less than 95%) or no alumina platelets.

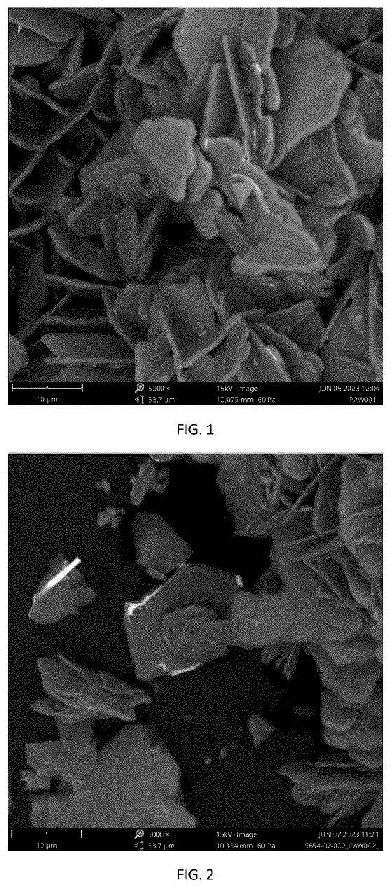

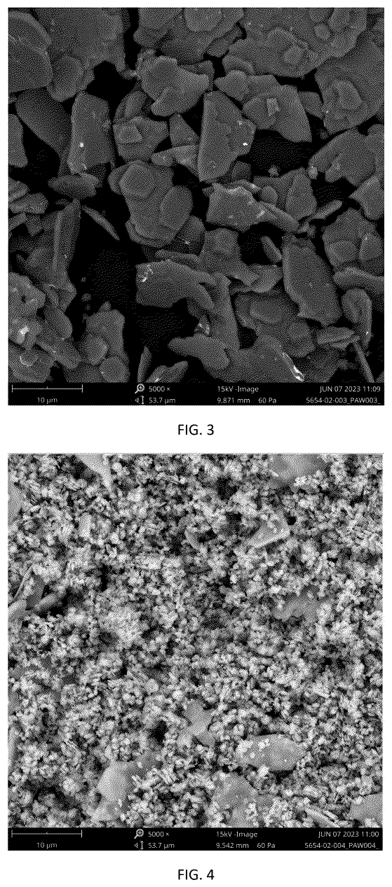

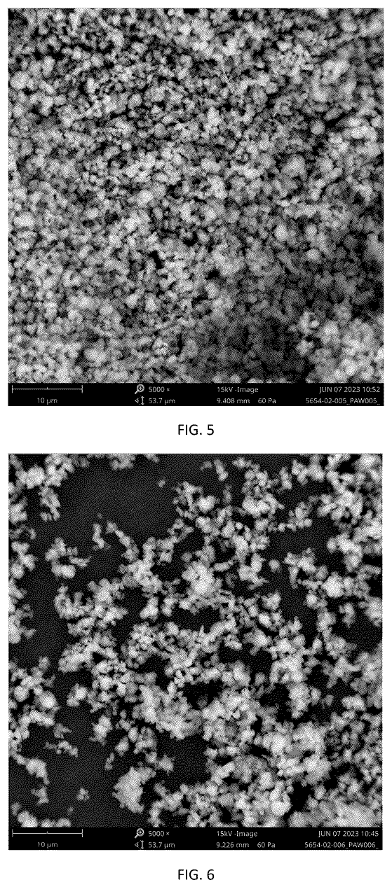

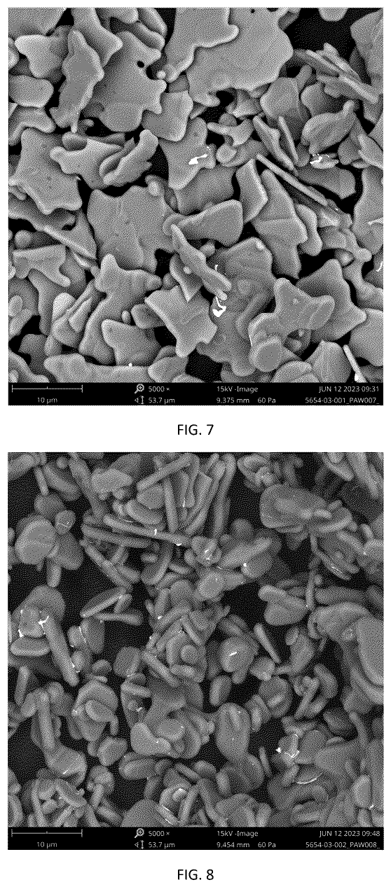

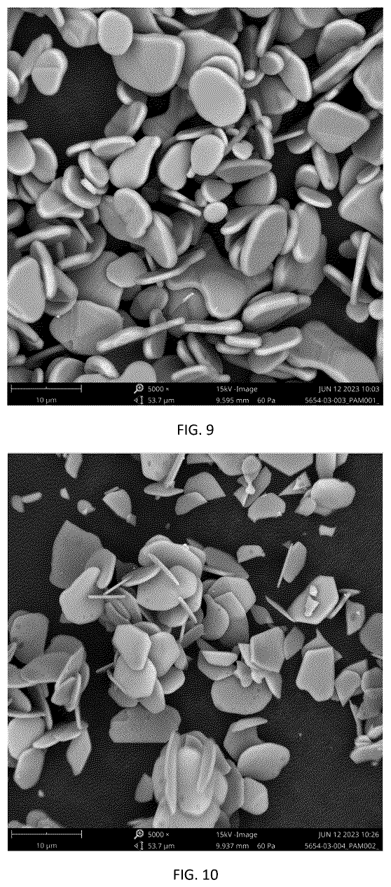

TABLE 2C
Platelet Alumina Powder Analysis Using WO₃ Flux

| Mixture | Alumina | | | WO₃ % |
|---|---|---|---|---|
| Composition | Powder | SEM Platelet | SEM | by XRF |
| 1 | 1 | 100, | FIG. 1 | 3.2 |
| 2 | 2 | 100 | FIG. 2 | N/A |
| 3 | 3 | Substantially | FIG. 3 | N/A |
| | | 100 | | |
| 4 | 4 | Some | FIG. 4 | N/A |
| 5 | 5 | None | FIG. 5 | N/A |
| 6 | 6 | None | FIG. 6 | N/A |
| 7 | 7 | 100 | FIG. 7 | 1.1 |
| 8 | 8 | 100, thick | FIG. 8 | 1.9 |

Notably, it was observed that 100% platelet alumina (alumina powders 1-3 listed in Table 2C) having high aspect ratios formed at as low as 0.9 wt. % silica and 2.6 wt. % WO₃. This can be seen in the SEMS depicted in FIG. 1 (SEM of alumina powder 1), FIG. 2 (SEM of alumina powder 2) and FIG. 3 (SEM of alumina powder 3). Further reducing the silica and WO₃ to half that of mixture composition 3 levels still formed some platelets by most of the alumina particles remain still equiaxial particles (See, the results listed in Table 2C for alumina powder 4; and the SEM of alumina powder 4 shown in FIG. 4). At even lower levels of silica and WO₃ levels than mixture composition 4, no platelets alumina was observed (See, the results listed in Table 2C for alumina powders 5 and 6; and the SEM of alumina powders 5 and 6 shown in FIGS. 5 and 6, respectively).

When different alumina hydrate powders were investigated, i.e., Gibbsite-2 as in mixture composition 7, and Boehmite-1 as in mixture composition 8, rather than Gibbsite-1 used in mixture compositions 1-6, alumina powders having 100% alumina platelets were formed, See, for example, alumina power 7 and the SEM of alumina powder 7 shown in FIG. 7 and alumina power 8 and the SEM of alumina powder 8 shown in FIG. 8. Both alumina power 7 and alumina powder 8 had different platelet features such as shape and thickness than those of alumina powders 1-3. These variations indicated that the platelet morphologies could be manipulated by varying the choice of alumina hydrate powder that was used in the initial mixture composition.

The white spots observed in FIG. 1 of alumina powder 1 had been qualitatively identified as tungsten. Semi quantitative analysis of alumina powers 1, 7 and 8 all confirmed the presence of WO₃, however, the levels of WO₃ were clearly lower than the calculated levels; some loss of WO₃ could be due to sublimination during the high temperature calcination that was used in forming the respective alumina powders.

### Example 2: Molybdenum Oxide Assisted Alumina Powder Platelet Formation

In this example, various alumina powders were prepared using a MoO₃ fluxing agent. Notably, mixture composition 9-15 as identified in Table 3A were prepared by slurring an alumina hydrate powder, as listed in Table 3A and further identified in Table 1, with various levels of silica and MoO₃, as also listed in Table 3A, in deionized (DI) water. The slurry solid content for each of mixture compositions 9-15 is provided in Table 3B. Based on the data provided in Example 1 above, the silica and MoO₃ levels were kept relatively narrow and started with 0.5 silicon and 2.5% MoO₃ with either Gibbsite-2 or Boehmite-2.

TABLE 3A
Mixture Composition For Platelet Alumina
Powder Preparation Using MoO₃ Flux

| | Al₂O₃ | Alumina | Added silica | |
|---|---|---|---|---|
| Mixture | Content | Hydrate | Content | MoO₃ |
| Composition | (wt. %) | Powder | (wt. %) | (wt. %)¹ |
| 9 | 97.0 | Gibbsite-2 | 0.5 | 2.5 |
| 10 | 97.1 | Boehmite-2 | 0.5 | 2.4 |
| 11 | 98.5 | Gibbsite-2 | 0.2 | 1.3 |
| 12 | 97.3 | Boehmite-2 | 0.2 | 2.4 |
| 13 | 96.7 | Boehmite-2 | 0.9 | 2.4 |
| 14 | 95.9 | Boehmite-2 | 0.5 | 3.7 |
| 15 | 97.7 | Boehmite-2 | 0.5 | 1.9 |

¹Ammonium molybdate tetrahydrate (82% MoO₃)

After forming the mixture compositions listed in Table 3A, those mixture compositions were dried under a heat lamp and calcined using the conditions set forth in Table 3B.

TABLE 3B
Experimental Conditions For Platelet Alumina
Powder Preparation Using MoO₃ Flux

| | | | Calcining | |
|---|---|---|---|---|
| Mixture | Slurry | Drying Time | Temperature | Calcining Time |
| Composition | Solid % | (hrs) | (° C.) | (hrs) |
| 9 | 37 | 3 | 1450 | 3 |
| 10 | 43 | 3 | 1450 | 3 |
| 11 | 37 | 3 | 1450 | 3 |
| 12 | 43 | 3 | 1450 | 3 |
| 13 | 43 | 3 | 1450 | 3 |
| 14 | 43 | 3 | 1450 | 3 |
| 15 | 43 | 3 | 1450 | 3 |

Following the calcination process, alumina powders 9-15 were prepared from mixture compositions 9-15, respectively. As noted in Table 3C, alumina powers 9-10 and 12-15 had a 100% platelet morphology, while alumina powder 11 has a substantially 100% platelet morphology.

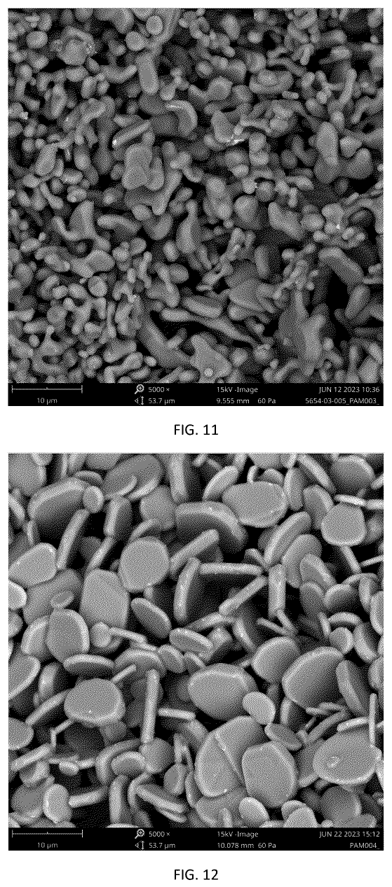

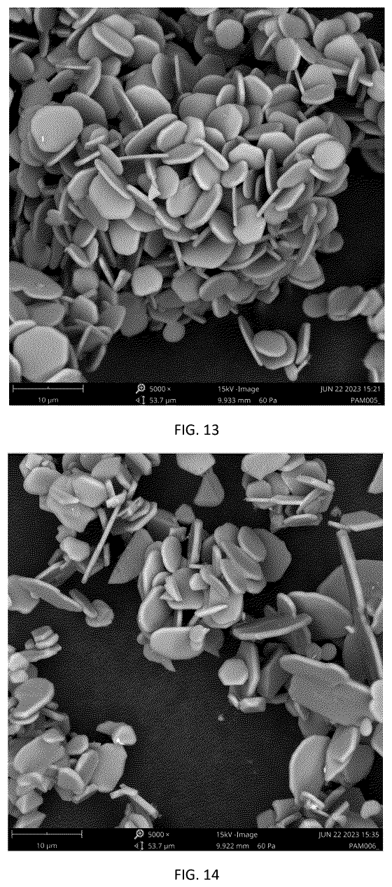

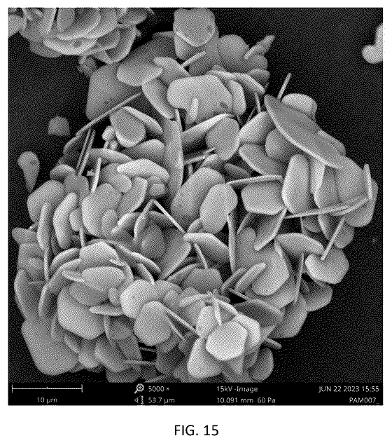

TABLE 3C
Platelet Alumina Powder Analysis Using MoO₃ Flux

| Mixture | Alumina | | | MoO₃ % |
|---|---|---|---|---|
| Composition | Powder | SEM Platelet | SEM | by XRF |
| 9 | 9 | 100 | FIG. 9 | 0.27 |
| 10 | 10 | 100 | FIG. 10 | 0.22 |
| 11 | 11 | Substantially | FIG. 11 | N/A |
| | | 100 | | |
| 12 | 12 | 100 | FIG. 12 | N/A |
| 13 | 13 | 100 | FIG. 13 | N/A |
| 14 | 14 | 100 | FIG. 14 | N/A |
| 15 | 15 | 100 | FIG. 15 | N/A |

Comparing alumina power 9 vs alumina powder 10, it was clear that alumina powder 10 which was made using Boehmite-2 showed similar platelet size, but much thinner platelets than alumina powder 9 which was made with Gibbsite-2; note that Boehmite-2 is finer than Gibbsite-2 (See, Table 1). As such, alumina powder 10 would have a much higher aspect ratio that would translate to a higher surface area than alumina powder 9. The SEMs of alumina powder 9 and alumina powder 10 are shown in FIGS. 9 and 10, respectively.

Alumina powder 11 was made with lower silica and MoO₃ levels than either alumina powder 9 or alumina powder 10, and alumina powder 11 showed substantial platelet formation as can be seen in the SEM provided in FIG. 11. This demonstrated that it is possible to vary silica and MoO₃ levels to dictate the resultant alumina particle size and morphology.

To further explore the effects of silica and MoO₃ and their ratios on the morphology, silica was varied from 0.2 to 0.9 wt. % while MoO₃ was varied from 1.9 to 3.7 wt. % for the same boehmite based samples, see mixture compositions 12-15 and alumina powders 12-15 in Tables 3A and 3C and FIGS. 12-15. Reducing silica to a very low level of 0.2 wt. % while keeping relatively high MoO₃ in mixture composition 12 led to alumina powder 12 having a thicker platelet (see, the SEM shown in FIG. 12) and increasing silica to 0.9 wt. % while maintaining MoO₃ at 2.4 wt. % in mixture composition 13 indeed made an alumina powder 13 that had thinner and smaller platelets (see, for example, the SEM shown in FIG. 13. For these conclusions, it seems that a sufficient amount of silica is required to produce thinner platelets (higher aspect ratios).

For alumina powder 14 made from mixture composition 13 with a high MoO₃ content of 3.7 wt. % and 0.5 wt. % silica, the SEM in FIG. 14 shows some larger but relatively thin platelets. A relatively thinner platelet morphology (high aspect ratios) was observed for alumina powder 15 (see, for example, the SEM shown in FIG. 15) when 0.5 wt. % silica and 1.9 wt. % MoO₃ were applied to Boehmite-2 based composition mixture 15.

Another observation for the MoO₃ assisted alpha alumina powder formation is that the MoO₃ content in the final platelet alumina powder was significantly lower than calculated MoO₃ loading, see alumina powders 9-10, XRF analysis that only showing about 0.22 wt. %-0.27 wt. % MoO₃ while approximately 2.5 wt. % was introduced, approximately 90% loss of MoO₃ in the process. It is likely that significant sublimation had occurred during the high temperature calcination. The remaining free MoO₃ could be further removed by washing with water or dilute base because of the high solubility of MoO₃.

### Example 3: Platelet Alumina Carrier Formation

In this example, WO₃ and MoO₃ fluxes have been incorporated into the alumina hydrate based carrier forming process to produce platelet alumina in-situ. See Table 4A for the carrier formulations that were used in forming Carriers 1-4. Each of carriers 1-4 were prepared by adding the tabulated amount of fluxing agent, (i.e., WO₃ and MoO₃) disclosed in Table 4A to a carrier composition that included one of the alumina powders identified in Table 4A. This resultant mixture was then mixed to provide an admixture and thereafter the admixtures were extruded. Each of the extruded admixtures were then calcined at a temperature of about 1250° C. to convert the extruded admixtures into alpha alumina carriers. The physical properties of each of carriers 1-4 that were formed are summarized in Tables 4B and 4C.

TABLE 4A
Carrier Formulation

| | | | Added | Ammonium | Ammonium | | |
|---|---|---|---|---|---|---|---|
| | | | Silica Content | Metatungstate | Molybdate | | |
| | | | (wt. % based | (wt. % based | (wt. % based | | |
| | Gibbsite-2 | Boehmite-1 | on alumina | on alumina | on alumina | PM500¹ | PJ² |
| Carrier | (wt. %) | (wt. %) | hydrate) | hydrate) | hydrate) | (%) | (%) |
| 1 | 100 | | 0.5 | 2.0 | | 7 | 13 |
| 2 | 100 | | 0.5 | | 2.1 | 7 | 13 |
| 3 | | 100 | 0.7 | 2.6 | | 9 | 13 |
| 4 | | 100 | 0.7 | | 2.7 | 9 | 17 |

¹Finely micronized polypropylene powders from Micro Powders, Inc.
²Industrial Petroleum Jelly White USP Grade produced by Caseway Industrial Products, Inc.

TABLE 4B
Carrier Properties

| | | | Average | | | |
|---|---|---|---|---|---|---|
| | | Water | Crush | | PV % less | Pore |
| | BET | Absorption | Strength | HgPV | than 0.3 | Modes |
| Carrier | (m²/gm) | (%) | (Newtons, N) | (ml/g) | μm | (μm) |
| 1 | 0.83 | 60 | 18 | 0.61 | 0.0 | 2.3 |
| 2 | 1.06 | 82 | 22 | 0.83 | 0.0 | 2.4 |
| 3 | 0.86 | 35 | 120 | 0.34 | 0.2 | 1.4 |
| 4 | 1.23 | 75 | 135 | 0.76 | 0.0 | 2.4 |
| 4 (Post | 1.18 | 74 | 105 | 0.75 | 0.1 | 2.4 |
| wash) | | | | | | |

TABLE 4C
XRF Analysis Data on Carrier

| | Na₂O | AlₛO₃ | SiO₂ | K₂O | CaO | Fe₂O₃ | WO₃ | MoO₃ |
|---|---|---|---|---|---|---|---|---|
| Carrier | (%) | (%) | (%) | (%) | (%) | (%) | (%) | (%) |
| 1 | 0.091 | 98.969 | 0.346 | 0.009 | 0.013 | 0.021 | 0.542 | 0.002 |
| 2 | 0.078 | 99.222 | 0.324 | 0.007 | 0.015 | 0.025 | 0.044 | 0.276 |
| 3 | 0.089 | 97.817 | 0.355 | 0.015 | 0.020 | 0.020 | 1.632 | N/A |
| 4 | 0.060 | 99.356 | 0.382 | 0.009 | 0.023 | 0.018 | N/A | 0.137 |
| 4 (Post | 0.035 | 99.587 | 0.293 | 0.015 | 0.015 | 0.019 | N/A | 0.030 |
| wash) | | | | | | | | |

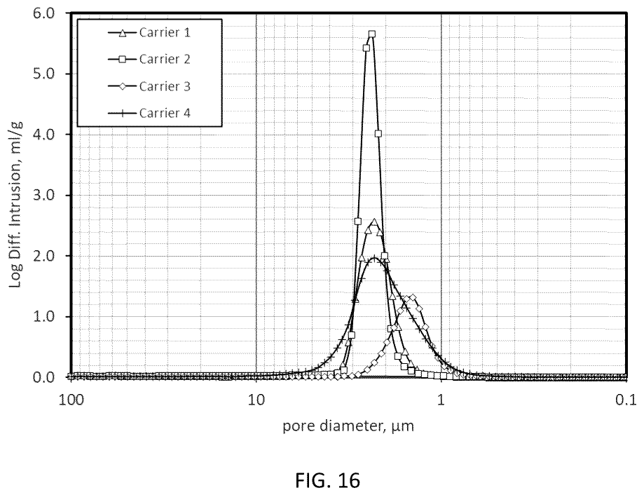

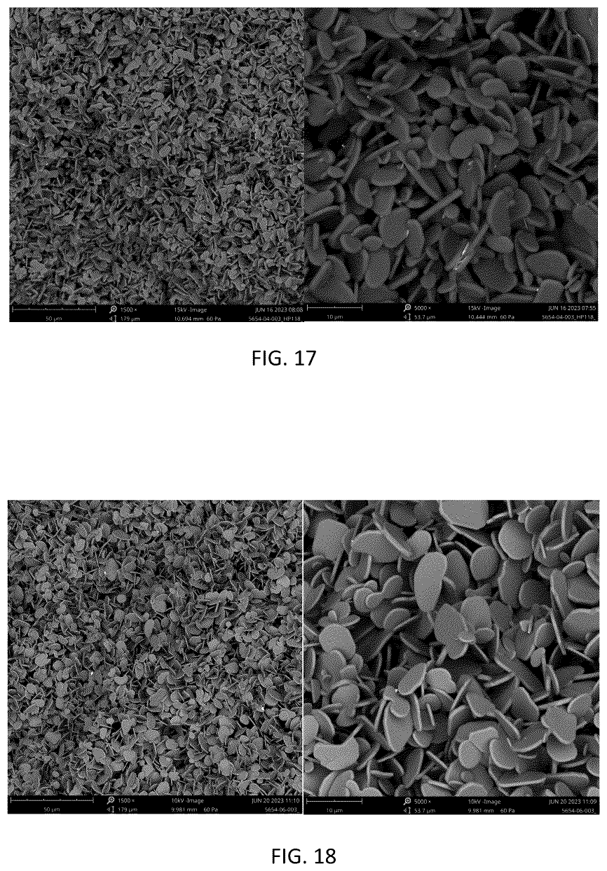

Carrier 1 exhibited high water absorption, relatively low surface area and a very low crush strength. The HgPVD in FIG. 16 showed a monomodal pore size distribution centered around 2.3 μm, no small pores below 0.3 μm were observed. The fractured surface SEM in FIG. 17 of Carrier 1 showed an all-platelet, very uniform platelet morphology with a platelet size of less than 10 μm and a platelet thickness of less than 1 μm, an estimated aspect ratio of about 10.

Carrier 2 exhibited a relatively higher surface area, very high water absorption, but very low crush strength, than carrier 1. Carrier 2 was monomodal having a monomodal pore size distribution centered at 2.4 μm with no small pores below 0.3 μm (See, FIG. 16). The fractured SEM images in FIG. 18 also showed highly platelet morphology similar to carrier 1 but looks slightly larger and thinner that possibly contributed to the somewhat higher surface area for carrier 2.

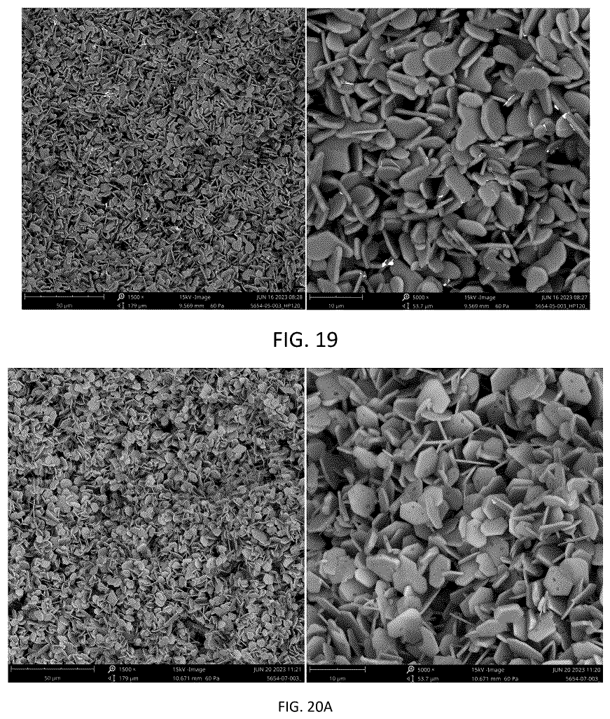

Carrier 3 also had all platelet morphology (see, FIG. 19) with a monomodal pore size distribution (see, FIG. 16), low surface area, very similar to carrier 1 but excellent crush strength, however, water absorption was unexpectedly low for carrier 3.

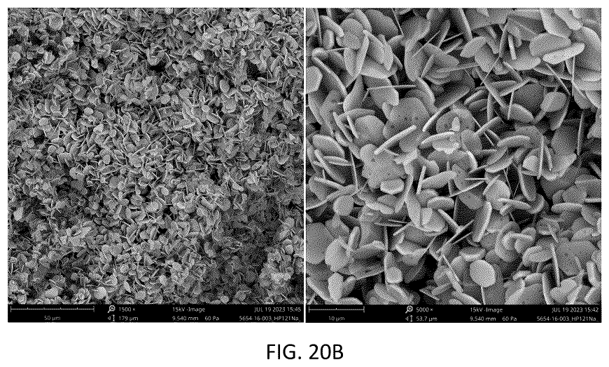

Carrier 4 showed a relatively high surface area (1.23), very high water absorption (75%) with excellent crush strength. The HgPVD in FIG. 16 showed a monomodal pore size distribution centered at 2.4 μm with no pores below 0.3 μm. The fractured surface SEM for Carrier 4 exhibited very uniform platelet (mostly well-defined hexagonal) morphology and open porosity (See, FIG. 20A), the platelet size was about 5 μm, and the thickness varied between about 0.2 μm-0.5 μm that provides an estimated aspect ratio as high as 25. The small particle size and high aspect ratio contributed to the higher surface area achieved for carrier 4.

Carriers 1-4 are expected to be suitable carriers for a silver-based epoxidation catalyst as described in this disclosure. Carriers 1-4 are expected to contain high concentrations of molybdenum oxide that may negatively impact the carrier performance but as observed in the Example 2, most of the molybdenum oxide has been removed during higher temperature firing from the platelet alumina powders likely via sublimation. That is also observed for carriers 1-4, for example, carrier 4 had a calculated MoO₃ content about 2%, but as shown in Table 4C, post calcined carrier 4 only contained ˜0.14% MoO₃. A simple wash of carrier 4 with a 0.025M NaOH solution further reduced the MoO₃ content in carrier 4 to 0.03%, that's about 99% removal of MoO₃ from the original loading. The remaining MoO₃ in the washed carrier 4 is likely retained deep in the grain boundaries that may not influence carrier performance significantly.

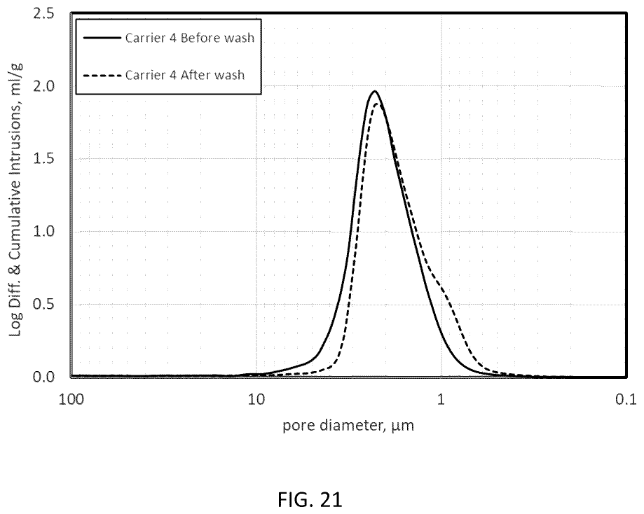

The post washed carrier 4 retained most of the properties including surface area (about 1.2), water absorption (about 74%), and crush strength (about 105N). Fractured surface SEM in FIGS. 20A and 20B showed the almost identical platelet morphologies for carrier 4 before and after wash. A very similar HgPVD with monomodal pore size distribution before and after wash is shown in FIG. 21.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A method of forming an alumina powder having platelet morphology, the method comprising:
forming an aqueous slurry comprising an alumina source and a fluxing agent, wherein the fluxing agent has a formula MO₃ wherein M is a metal selected from Cr, Mo and W, and wherein the fluxing agent is present in the aqueous slurry in an amount from about 0.1 weight % to about 5 weight %, based on the total weight of the alumina source;
drying the slurry to provide a solid product; and
calcining the solid product at a temperature of about 1200° C. greater to convert the solid product into a substantially all platelet alumina powder.

2. The method of claim 1, wherein M is Mo.

3. The method of claim 1, wherein M is W.

4. The method of claim 1, wherein the fluxing agent is present in the aqueous slurry in an amount from about 0.1 weight % to about 5 weight %, based on the total weight of the alumina source.

5. The method of claim 1, wherein the alumina source comprises a transition alumina.

6. The method of claim 1, wherein the transition alumina comprises a hydrated alumina.

7. The method of claim 1, wherein the alumina source is present in the aqueous slurry in an amount from about 10 weight % to about 80 weight %.

8. The method of claim 1, wherein the slurry further comprises silica, and the silica is present in the aqueous slurry in an amount from about 0.1 weight % to about 5 weight %, based on the total weight of the alumina source.

9. The method of claim 1, wherein the substantially all platelet alumina powder comprises greater than 96% platelets.

10. The method of claim 1, wherein the substantially all platelet alumina powder comprises 100% platelets.

11. The method of claim 1, wherein the substantially all platelet alumina powder has a platelet aspect ratio of from 5:1 or greater.

12. A method of forming an alumina carrier, the method comprising:
adding a fluxing agent to a carrier composition comprising an alumina source, wherein the fluxing agent has a formula MO₃ wherein M is a metal from selected from Cr, Mo and W, and wherein the fluxing agent is added in an amount from about 0.1 weight % to about 5 weight % based on the total weight of the alumina source;
mixing the fluxing agent and the carrier composition to provide an admixture of the fluxing agent and the carrier composition;
forming the admixture into a shaped body and
calcining the shaped body at a temperature of about 1200° C. greater to convert the shaped body into a substantially all platelet alumina carrier.

13. The method of claim 12, wherein M is Mo, and the fluxing agent comprises ammonium molybdate.

14. The method of claim 12, wherein M is W, and the fluxing agent comprises ammonium metatungstate.

15. The method of claim 12, wherein the fluxing agent is added in an amount from about 0.1% to about 5 weight % based on the total weight of the alumina source.

16. The method of claim 12, wherein the alumina source comprises a transition alumina.

17. The method of claim 12, wherein the transition alumina comprises a hydrated alumina.

18. The method of claim 12, wherein the carrier composition further comprises silica, and the silica is present in the carrier composition in an amount from about 0.1 weight % to about 5 weight %, based on the total weight of the alumina source.

19. The method of claim 12, wherein the substantially all platelet alumina carrier comprises greater than 96% platelets.

20. The method of claim 12, wherein the substantially all platelet alumina comprises 100% platelets.

21. The method of claim 12, wherein the substantially all platelet alumina carrier has a platelet aspect ratio of from 5:1 or greater.

22. The method of claim 12, wherein the substantially all platelet alumina carrier has a surface area from about 0.2 m²/gm to about 2 m²/gm, a water absorption from about 30% to about 90%, a mercury pore volume from about 0.3 ml/g to about 0.9 ml/g, and an average crush strength from about 5 N to about 200 N.

23. The method of claim 12, wherein the substantially all platelet alumina carrier contains less than 1% of pores having a pore volume of less than 0.3 μm.

24. The method of claim 12, wherein the substantially all platelet alumina carrier has a pore mode within a range from about 0.5 μm to about 5 μm.
